(19) United States
(12) Patent Application Publication
(10) Pub. No.: US 2017/0148246 A1
(43) Pub. Date: May 25, 2017

(54) THICKNESS DETECTION DEVICE

(71) Applicant: GRG BANKING EQUIPMENT CO., LTD., Guangzhou, Guangdong (CN)

(72) Inventors: Ming LI, Guangzhou, Guangdong (CN); Xiaoqun HUANG, Guangzhou, Guangdong (CN)

(73) Assignee: GRG BANKING EQUIPMENT CO., LTD., Guangzhou, Guangdong (CN)

(21) Appl. No.: 15/319,939

(22) PCT Filed: Dec. 8, 2014
(86) PCT No.: PCT/CN2014/093256

§ 371 Date: Dec. 19, 2016

(30) Foreign Application Priority Data
Jun. 30, 2014 (CN) 201410309886.8

(51) Int. Cl. G07D 7/16; G01N 29/04; G01N 29/44; G07D 7/08; G01B 17/02

(52) U.S. Cl. CPC G07D 7/164; G07D 7/08; G01B 17/02; G01N 29/4445; G01N 29/041; G01N 2291/0237; G01N 2291/0289

(57) ABSTRACT

A thickness detection device, which is used for avoiding the condition where abnormal features, such as foreign matter and damaged apertures, pass through a gap, so that the thickness detection device does not have a detection blind area. The thickness detection device comprises: a plurality of thickness sensors (1101, 1102, 1103 . . . 1111, 1112) which are divided into two rows, i.e. a front row and a rear row in the advance direction of a slice medium, wherein an interlaced distribution is formed between the two rows of thickness sensors (1101, 1102, 1103 . . . 1111, 1112), so that any point on the slice medium passes through the sensing coverage range of the thickness sensors (1101, 1102, 1103 . . . 1111, 1112) in the advance direction.

This application claims priority to Chinese Patent Application No. 201410309886.8 titled “THICKNESS DETECTION DEVICE” and filed with the State Intellectual Property Office of People's Republic of China on Jun. 30, 2014, which is incorporated herein by reference in its entirety.

### FIELD

The present disclosure relates to the technical field of electronics, particularly to a thickness detection device.

### BACKGROUND

With the diversification of people's life, thickness detection of a sheet medium is gradually put into application, and is applied in more and more fields. For example, an ATM or a paper money sorter in the commercial field needs to perform thickness detection on paper money, to recognize whether there is an abnormal characteristic such as a breakage, a pasted foreign matter or a tear on the paper money. The authenticity of the paper money can be distinguished by sensing a thickness of the paper money as well.

Currently, the thickness detection of a sheet medium is normally performed by splicing signals detected by multiple separate thickness sensors arranged in one row together to obtain a thickness characteristic of a whole banknote, to recognize whether the banknote is abnormal.

However, in measuring with thickness sensors arranged in one row, gaps are required between the thickness sensors, for there will be mutual interferences if the thickness sensors are too close. Thus, these thickness sensors cannot detect an abnormal characteristic such as a foreign matter or a hole if the abnormal characteristic passes through the gaps, thereby resulting in a blind detection zone.

### SUMMARY

A thickness detection device is provided according to embodiments in the present disclosure, to prevent an abnormal characteristic such as a foreign matter or a hole from passing through a gap, so that the thickness detection device does not have a blind detection zone.

The thickness detection device provided according to the embodiments in the present disclosure includes: multiple thickness sensors.

The multiple sensors are arranged in two rows in an advancing direction of a sheet medium, and the two rows are arranged in a staggered manner, such that any point on the sheet medium passes through a sensing coverage of the multiple thickness sensors in the advancing direction.

Optionally, the thickness detection device further includes a transmitting circuit board and a receiving circuit board.

The transmitting circuit board and the receiving circuit board are installed in pair, an advancing channel for the sheet medium is formed between the transmitting circuit board and the receiving circuit board.

The multiple thickness sensors are installed on the transmitting circuit board and the receiving circuit board.

Optionally, the multiple thickness sensors include transmitting probes and receiving probes.

The transmitting probes are installed on the transmitting circuit board, and the receiving probes are installed on the receiving circuit board.

The transmitting probes and the receiving probes are installed in a one-to-one correspondence relationship.

Optionally, the transmitting circuit board is configured to control the transmitting probes to transmit a detection signal, which passes through the sheet medium and is received by the receiving probes as a new detection signal.

Optionally, the thickness detection device further includes:

an analyzing module, configured to acquire the new detection signal from the receiving circuit board and perform a signal intensity analysis on the new detection signal, to obtain a thickness of the sheet medium based on a relation between signal intensity and thickness.

Optionally, the transmitting probes include ultrasonic transmitting probes, and the receiving probes include ultrasonic receiving probes.

Optionally, the N pairs of transmitting probe and receiving probe are divided into X groups each including Y transmitting probes and Y receiving probes, where X multiplied by Y is N.

The transmitting probes and the receiving probes in a same group perform transmitting operations and receiving operations synchronously.

The X groups of transmitting probes and receiving probes operate in a predetermined group sequence.

Optionally, the transmitting circuit board further includes:

Y drive circuits, connected to the Y transmitting probes in each of the X groups respectively and configured to drive the transmitting probes to transmit the detection signal; and

a first one-of-X switch, connected to the X groups of transmitting probes and configured to turn on the transmitting probes in one of the X groups simultaneously in the predetermined group sequence.

Optionally, the receiving circuit board further includes:

N pre-amplification circuits, connected to the N receiving probes respectively and configured to perform preliminary amplification on the new detection signal received by the receiving probes;

Y second one-of-X switches and Y amplifying and shaping circuits, where each of the second one-of-X switches is connected to X of the N pre-amplification circuits and one of the Y amplifying and shaping circuits, and is configured to select the receiving probe belonging to a current group from the X receiving probes connected to the X pre-amplification circuits in the predetermined group sequence; and

where each of the Y amplifying and shaping circuits is configured to perform an amplifying and shaping process on the new detection signal sent by the second one-of-X switch connected to the amplifying and shaping circuit; and

an AD converter, connected to the Y amplifying and shaping circuits and configured to perform an AD conversion on the new detection signal sent by the Y amplifying and shaping circuits and then send the new detection signal on which the AD conversion is performed to the analyzing module.

Optionally, the analyzing module is further configured to determine that there is an abnormal characteristic on the sheet medium if signal intensity of the new detection signal is not within a predetermined intensity interval, where the abnormal characteristic includes a tear, a breakage and a pasted foreign matter on the sheet medium; or the analyzing module is further configured to determine that the sheet medium is defective if an average thickness of the sheet medium is not within a predetermined thickness interval.

It follows from the above technical solutions that, the embodiment in the present disclosure has the advantages as follows.

The thickness detection device provided according to the embodiments in the present disclosure includes multiple thickness sensors which are arranged in two rows in an advancing direction of a sheet medium, and the two rows are arranged in a staggered manner, such that any point on the sheet medium passes through a sensing coverage of the multiple thickness sensors in the advancing direction. In the embodiments in the present disclosure, by arranging the multiple thickness sensors in the thickness detection device in two rows, and arranging the two rows in a staggered manner, any point on the sheet medium passes through a sensing coverage of the multiple thickness sensors in the advancing direction, thereby preventing an abnormal characteristic such as a foreign matter or a hole from passing through a gap, so that the thickness detection device does not have a blind detection zone.

### BRIEF DESCRIPTION OF THE DRAWINGS

FIG. 1 is a distribution diagram of a sensing coverage of multiple thickness sensors in a thickness detection device according to an embodiment in the present disclosure;

FIG. 2 is a schematic structural diagram of a thickness detection device according to an embodiment in the present disclosure;

FIG. 3 is an schematic diagram of arrangement of transmitting probes in a thickness detection device according to an embodiment in the present disclosure;

FIG. 4 is an schematic diagram of arrangement of receiving probes in a thickness detection device according to an embodiment in the present disclosure;

FIG. 5 is a schematic structural diagram of a transmitting circuit board in a thickness detection device according to an embodiment in the present disclosure;

FIG. 6 is a schematic structural diagram of a receiving circuit board in a thickness detection device according to an embodiment in the present disclosure;

FIG. 7 is a schematic diagram of a piece of adhesive tape passing through a sensing coverage of one ultrasonic probe;

FIG. 8 illustrates sensing waveforms of ultrasonic probes in the case as shown in FIG. 7;

FIG. 9 is a schematic diagram of a piece of adhesive tape passing through a sensing coverage of two ultrasonic probes; and

FIG. 10 illustrates sensing waveforms of ultrasonic probes in the case as shown in FIG. 9.

### DETAILED DESCRIPTION

A thickness detection device is provided according to embodiments in the present disclosure, which can prevent an abnormal characteristic such as a foreign matter or a hole from passing through a gap, so that the thickness detection device does not have a blind detection zone.

In order to make the object, characteristics and advantages of the technical solutions to be more apparent and better understood, embodiments in the present disclosure are described clearly and completely hereinafter with reference to the drawings. Apparently, the described embodiments are only a part of the embodiments. Any other embodiment obtained by those skilled in the art based on the embodiments in the present disclosure without any creative work fall in the scope of the present disclosure.

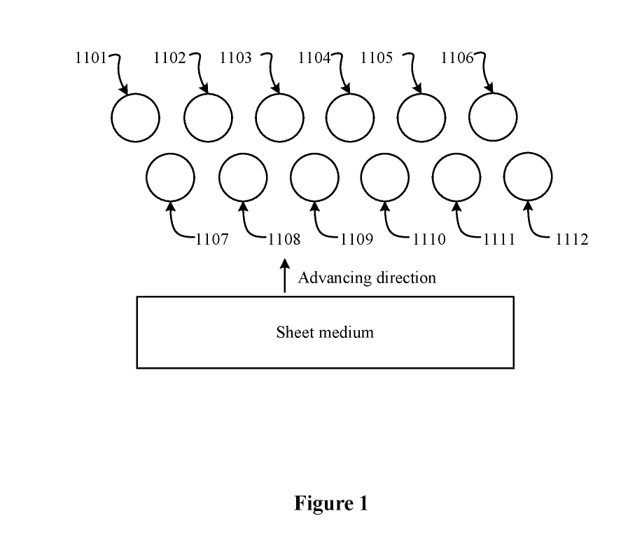

As illustrated in FIG. 1, a thickness detection device provided according to an embodiment in the present disclosure includes multiple thickness sensors.

The multiple thickness sensors are arranged in two rows in an advancing direction of a sheet medium, and the two rows are arranged in a staggered manner, such that any point on the sheet medium will pass through a sensing coverage of the multiple thickness sensors in the advancing direction.

It is understood that gaps are required between the multiple thickness sensors, which are not allowed to be too close to avoid interferences between the multiple thickness sensors. The sensing coverage of each of the multiple thickness sensors may be the same as or a little larger than a size of a sensing probe of the thickness sensor. FIG. 1 is a distribution diagram of the sensing coverage of the multiple thickness sensors in the thickness detection device, where 1101, 1101, 1103, 1104 . . . , 1111 and 1112 represent a sensing coverage of 12 thickness sensors. As can be seen from FIG. 1, 1101, 1101, 1103, 1104 . . . , 1111 and 1112 are arranged in two rows in an advancing direction, and the two rows are arranged in a staggered manner, such that any point on the sheet medium will pass through the sensing coverage in the advancing direction.

It should be noted that the sensing coverage 1101, 1101, 1103, 1104 . . . , 1111 and 1112 is only sensing coverage of 12 thickness sensors in the thickness detection device according to the embodiment. FIG. 1 only illustrates one distribution, while there may be other distributions in practice. The number of the multiple thickness sensors in the thickness detection device may be larger than or smaller than 12, which may be designed as needed and is not limited herein.

The thickness detection device provided according to the embodiment includes multiple thickness sensors which are arranged in two rows in an advancing direction of a sheet medium, and the tow rows are arranged in a staggered manner, such that any point on the sheet medium will pass through a sensing coverage of the multiple thickness sensors in the advancing direction. In the embodiment, by arranging the multiple thickness sensors in the thickness detection device in two rows and arranging the two rows in a staggered manner, any point on the sheet medium will pass through a sensing coverage of the multiple thickness sensors in the advancing direction, thereby preventing an abnormal characteristic such as a foreign matter or a hole from passing through a gap, so that the thickness detection device does not have a blind detection zone.

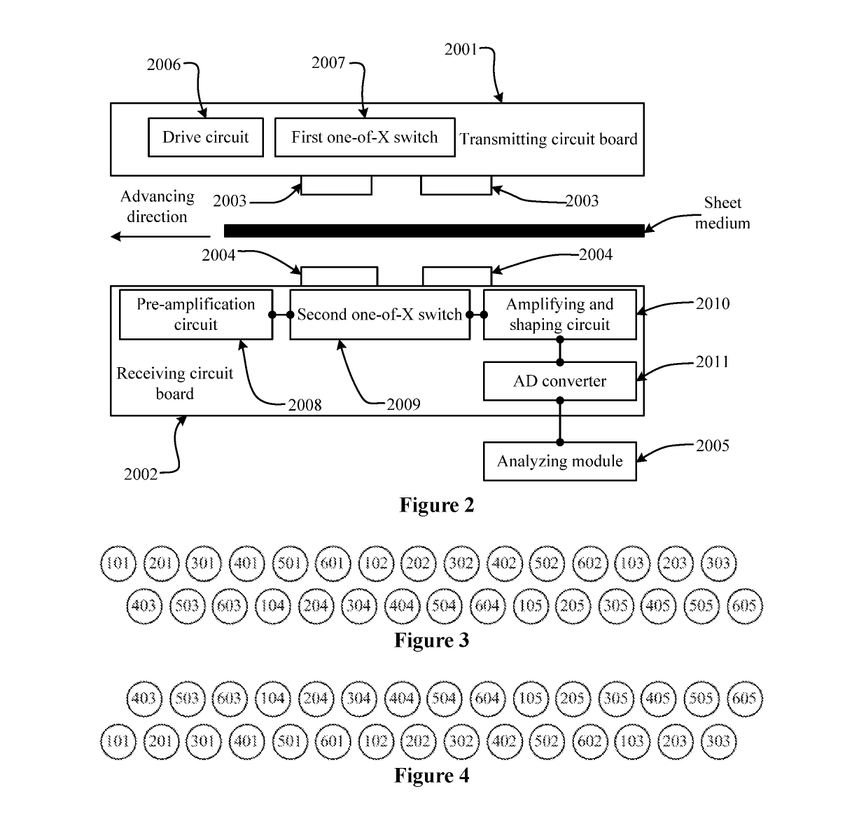

For better understanding, below a thickness detection device provided according to an embodiment in the present disclosure is described in detail. As illustrated in FIG. 2, the thickness detection device provided according to another embodiment in the present disclosure includes multiple thickness sensors.

The multiple thickness sensors are arranged in two rows in an advancing direction of a sheet medium, and the two rows are arranged in a staggered manner, such that any point on the sheet medium will pass through a sensing coverage of the multiple thickness sensors in the advancing direction.

The thickness detection device according to the embodiment may further include a transmitting circuit board 2001 and a receiving circuit board 2002.

The transmitting circuit board 2001 and the receiving circuit board 2002 are installed in pair, and an advancing channel for the sheet medium is formed between the transmitting circuit board 2001 and the receiving circuit board 2002.

The multiple thickness sensors are installed on the transmitting circuit board 2001 and the receiving circuit board 2002.

The multiple thickness sensors according to the embodiment may include transmitting probes 2003 and receiving probes 2004.

The transmitting probes 2003 are installed on the transmitting circuit board 2001, and the receiving probes 2004 are installed on the receiving circuit board 2002.

The transmitting probes 2003 and the receiving probes 2004 are installed in a one-to-one correspondence relationship.

It can be understood that a sheet medium passing through the advancing channel can be sensed by the transmitting probes 2003 and the receiving probes 2004 in cooperation with each other.

It should be noted that the transmitting circuit board 2001 is configured to control the transmitting probes 2003 to transmit a detection signal. The detection signal passes through the sheet medium and is received by the receiving probes 2004 as a new detection signal. Since the detection signal has passed through the sheet medium, some properties (for example, signal intensity) of the detection signal may be changed. Therefore, what the receiving probes 2004 received is the changed detection signal, i.e., the new detection signal.

The thickness detection device according to the embodiment in the present disclosure may further include an analyzing module 2005.

The analyzing module 2005 is configured to acquire the new detection signal from the receiving circuit board 2002 and perform a signal intensity analysis on the new detection signal, to obtain a thickness of the sheet medium based on a relation between signal intensity and thickness.

Preferably, the transmitting probes 2003 include ultrasonic transmitting probes, and the receiving probes 2004 include ultrasonic receiving probes.

It should be noted that in the embodiment, N pairs of transmitting probe 2003 and receiving probe 2004 can be divided into X groups each including Y transmitting probes 2003 and Y receiving probes 2004, where X multiplied by Y is N. The transmitting probes 2003 and receiving probes 2004 in a same group perform transmitting operations and receiving operations synchronously; and the X groups of transmitting probes 2003 and receiving probes 2004 operate in a predetermined group sequence. Below it is described with an example how to divide N pairs of transmitting probe 2003 and receiving probe 2004 into X groups and how the X groups of transmitting probes 2003 and receiving probes 2004 operate in a predetermined group sequence.

The transmitting circuit board 2001 according to the embodiment may further include Y drive circuits 2006 and a first one-of-X switch 2007.

The Y drive circuits 2006 are connected to the Y transmitting probes 2003 in each of the X groups respectively and are configured to drive the transmitting probes 2003 to transmit the detection signal.

The first one-of-X switch 2007 is connected to the X groups of transmitting probes 2003 and is configured to turn on the transmitting probes 2003 in one of the X groups simultaneously in the predetermined group sequence. It is understood that the first one-of-X switch 2007 is configured to select among the X groups of transmitting probes 2003, and thus the Y transmitting probes 2003 selected each time belong to a same group.

The receiving circuit board 2002 according to the embodiment may further include N pre-amplification circuits 2008, Y second one-of-X switches 2009, Y amplifying and shaping circuits 2010, and an AD converter 2011.

The N pre-amplification circuits 2008 are connected to the N receiving probes 2004 respectively and are configured to perform preliminary amplification on the new detection received by the receiving probes 2004.

Each of the second one-of-X switches 2009 is connected to X of the N pre-amplification circuits 2008 and one of the Y amplifying and shaping circuit 2010, and is configured to select the receiving probe 2004 belonging to a current group from the X receiving probes 2004 connected to the X pre-amplification circuits in the predetermined group sequence.

Each of the Y amplifying and shaping circuits 2010 is configured to perform an amplifying and shaping process on the new detection signal sent by the second one-of-X switch 2009 connected to the amplifying and shaping circuit.

The AD converter 2011 is connected to the Y amplifying and shaping circuits 2010, and is configured to perform an AD conversion on the new detection signal sent by the Y amplifying and shaping circuits 2010 and then send the new detection signal on which the AD conversion is performed to the analyzing module 2005.

In the embodiment, the analyzing module 2005 is further configured to determine that there is an abnormal characteristic on the sheet medium if signal intensity of the new detection signal is not within a predetermined intensity interval. The abnormal characteristic includes a tear, a breakage and a pasted foreign matter on the sheet medium.

Alternatively, the analyzing module 2005 is further configured to determine that the sheet medium is defective if an average thickness of the sheet medium is not within a predetermined thickness interval. It can be understood that the average thickness may function as a criterion to evaluate a general thickness of the sheet medium. If the average thickness of the sheet medium does not meet a predetermined requirement, i.e., the average thickness of the sheet medium is not within the predetermined thickness interval, the sheet medium is determined to be defective or an unexpected medium. For example, in detecting paper money by an ATM, if an average thickness of the paper money is not within a predetermined thickness interval, it can be determined that a general thickness of the paper money is different from that of normal paper money, and thus the paper money can be determined to be counterfeit money.

For better understanding the embodiment illustrated in FIG. 2, below a thickness detection device provided according to an embodiment is described with a practical application example.

It is assumed that 30 pairs of transmitting probe and receiving probe are provided, i.e., there are 30 transmitting probes and 30 receiving probes.

The 30 transmitting probes are arranged in two rows each including 15 transmitting probes, as illustrated in FIG. 3. The 30 transmitting probes are divided into 6 groups each including 5 transmitting probes. The grouping result is as follows:

a first group includes transmitting probes 101, 102, 103, 104 and 105;

a second group includes transmitting probes 201, 202, 203, 204 and 205;

a third group includes transmitting probes 301, 302, 303, 304 and 305;

a fourth group includes transmitting probes 401, 402, 403, 404 and 405;

a fifth group includes transmitting probes 501, 502, 503, 504 and 505; and

a sixth group includes transmitting probes 601, 602, 603, 604 and 605.

Similarly, since the transmitting probes and the receiving probes are installed in pairs, the receiving probes are arranged in two rows as well each including 15 receiving probes, as illustrated in FIG. 4. The receiving probes are divided into 6 groups each including 5 receiving probes. The grouping result is as follows:

a first group includes receiving probes 111, 112, 113, 114 and 115;

a second group includes receiving probes 211, 212, 213, 214 and 215;

a third group includes receiving probes 311, 312, 313, 314 and 315;

a fourth group includes receiving probes 411, 412, 413, 414 and 415;

a fifth group includes receiving probes 511, 512, 513, 514 and 515; and

a sixth group includes receiving probes 611, 612, 613, 614 and 615.

The transmitting probes and the receiving probes are in a rigorous one-to-one correspondence relationship. In operation, the first group of transmitting probes and the first group of receiving probes operate simultaneously, the second group of transmitting probes and the second group of receiving probes operate simultaneously, the third group of transmitting probes and the third group of receiving probes operate simultaneously, the fourth group of transmitting probes and the fourth group of receiving probes operate simultaneously, the fifth group of transmitting probes and the fifth group of receiving probes operate simultaneously, and the sixth group of transmitting probes and the sixth group of receiving probes operate simultaneously. Transmitting probe 101 corresponds to receiving probe 111, transmitting probe 102 corresponds to receiving probe 112, transmitting probe 103 corresponds to receiving probe 113 . . . , and so on.

In the whole operation process of the thickness detection device, the transmitting probes and the receiving probes are not required to operate all the time. The ultrasonic probes (including the transmitting probes and the receiving probes) each has a property of small detection region. For example, in a case that there is a hole in a detection object (for example, a banknote), assuming that a velocity of the banknote is 1600 mm/s and a sensing coverage of a ultrasonic probe is 8 mm, it takes 5 ms from the banknote entering the sensing coverage of the ultrasonic probe to the banknote moving out of the sensing coverage of the ultrasonic probe. That is, the ultrasonic probe is required to operate only once in the 5 ms rather than operating throughout the 5 ms order to detect the hole. For improving the resolution and determining based on multiple detections, the ultrasonic probes may be designed to detect once every 1.2 ms, for example. Currently, it takes less than 200 μs for a pair of ordinary ultrasonic probes to detect once. After a detection operation is completed by a group of ultrasonic probes operating synchronously, transmitting probes in the group stop transmitting an ultrasonic wave, and another group of ultrasonic probes are switched to operate. In this way, the 6 groups of ultrasonic probes can be switched to perform transmitting and receiving operations in 1.2 ms in a time-sharing manner. By configuring the transmitting probes and the receiving probes to perform transmitting and receiving operations in a time-sharing manner, not only a detection requirement of the thickness detection device can be met, but also a cost on hardware can be saved.

In the embodiment, the group sequence may be from the first group (including the first group of transmitting probes and the first group of receiving probes), then to the second group, then to the third group, then to the fourth group, then to the fifth group, then to the sixth group, and then back to the first group to circulate continuously. In a case of ultrasonic probes, a turn-on time period for each of the groups is about 200 μs, and it takes 1.2 ms to accomplish a complete double-row sampling. Besides, no transmitting probe or receiving probe is adjacent to another transmitting probe or receiving probe in each of the groups, which greatly reduces interferences caused by adjacency.

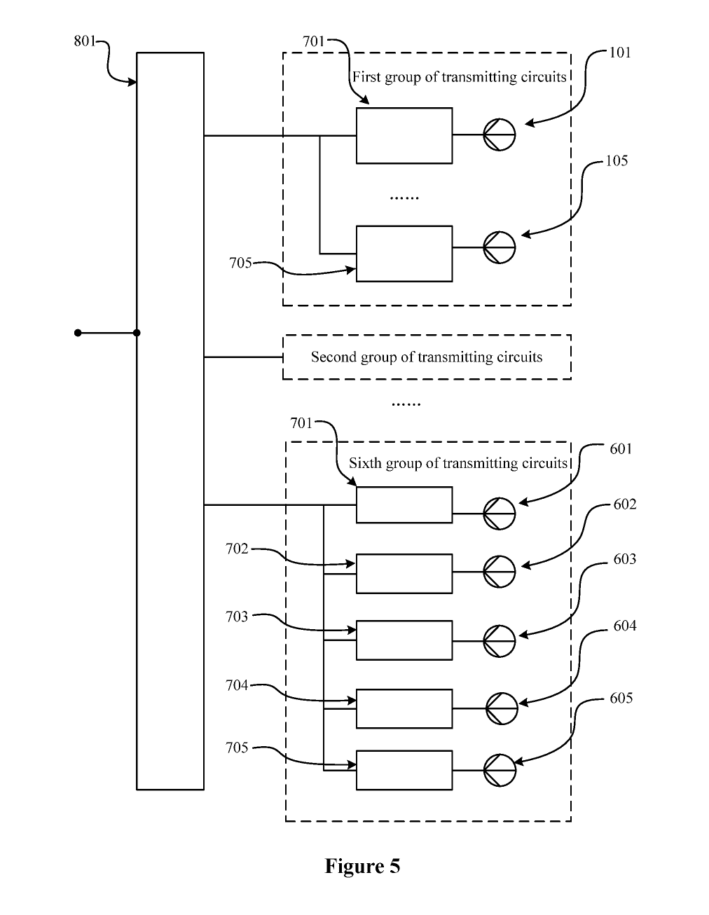

As illustrated in FIG. 5, the transmitting circuit board is provided with 5 drive circuits 701, 702, 703, 704 and 705. Drive circuit 701 is configured to drive transmitting probes 101, 201, 301, 401, 501 and 601. Drive circuit 702 is configured to drive transmitting probes 102, 202, 302, 402, 502 and 602. Drive circuit 703 is configured to drive transmitting probes 103, 203, 303, 403, 503 and 603. Drive circuit 704 is configured to drive transmitting probes 104, 204, 304, 404, 504 and 604. Drive circuit 705 is configured to drive transmitting probes 105, 205, 305, 405, 505 and 605.

The transmitting circuit board is further provided with an electronic one-of-six switch 801 which is configured to select one group of transmitting probes from the 6 groups of transmitting probes in the group sequence. Since transmitting probes of only one of the 6 groups operate at a time, the 5 drive circuits are enough for driving the 6 groups of transmitting probes. The 5 drive circuits are configured to drive the group of transmitting probes determined by the electronic one-of-six switch.

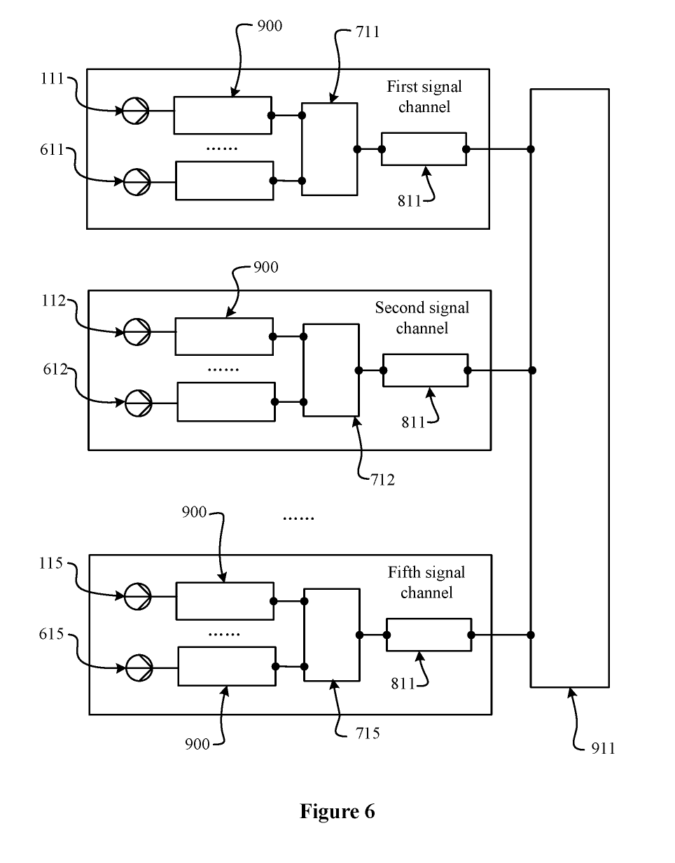

As illustrated in FIG. 6, the receiving circuit board is provided with 30 pre-amplification circuits 900 connected to the 30 receiving probes respectively. The receiving circuit board is further provided with 5 electronic one-of-six switches, i.e., switches 711, 712, 713, 714 and 715. Switch 711 is configured to select one from receiving probes 111, 211, 311, 411, 511 and 611. Switch 712 is configured to select one from receiving probes 112, 212, 312, 412, 512 and 612. Switch 713 is configured to select one from receiving probes 113, 213, 313, 413, 513 and 613. Switch 714 is configured to select one from receiving probes 114, 214, 314, 414, 514 and 614. Switch 715 is configured to select one from receiving probes 115, 215, 315, 415, 515 and 615. The 5 electronic one-of-six switches operate in synchronization with the electronic one-of-six switch 801 on the transmitting circuit board. If the electronic switch 801 selects the first group of transmitting probes, then switch 711 selects receiving probe 111, switch 712 selects receiving probe 112, switch 713 selects receiving probe 113, switch 714 selects receiving probe 114, and switch 715 selects receiving probe 115. As can be seen, receiving probes 111, 112, 113, 114 and 115 constitute the first group of receiving probes. In this way, the first group of transmitting probes and the first group of receiving probes can operate simultaneously, and the transmitting probes and the receiving probes are synchronous rigorously. The situation in which the electronic switch 801 select the second group, the third group, the fourth group or the fifth group is similar to the above, which is not described herein.

As illustrated in FIG. 6, the receiving circuit board is further provided with 5 amplifying and shaping circuits 811 and an AD converter 911. The 5 amplifying and shaping circuits are connected to the 5 electronic one-of-six switches, respectively.

An application scenario that a banknote pasted with a piece of adhesive tape enters the thickness detection device is described below.

For the banknote entering the thickness detection device, the piece of adhesive tape can be detected in the following two cases if the piece of adhesive tape is narrow.

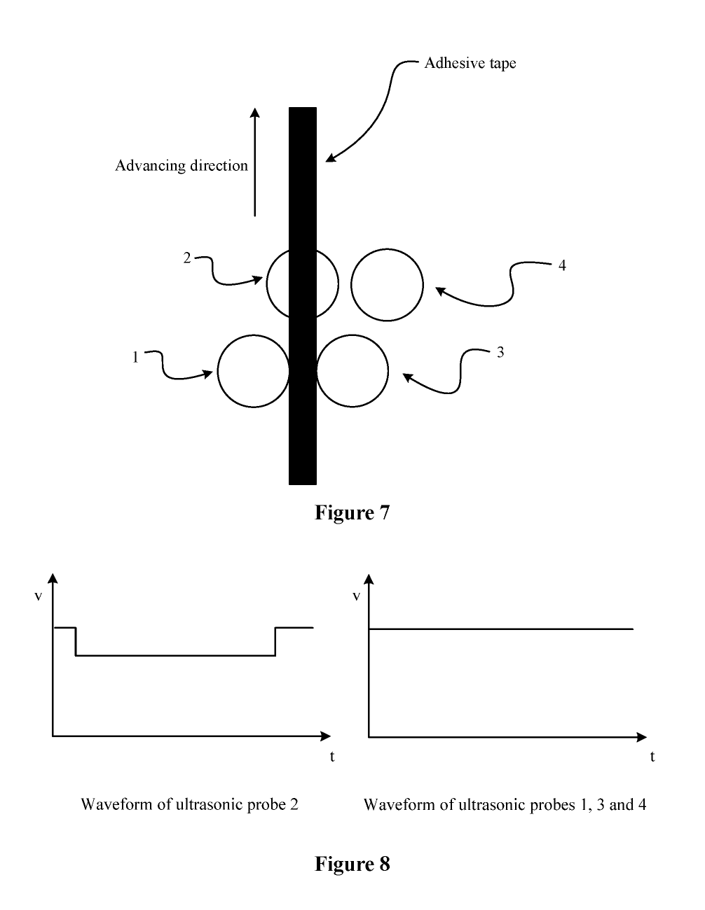

In a first case, the piece of adhesive tape passes through a sensing coverage of only one ultrasonic probe, as illustrated in FIG. 7. In this case, sensing waveforms of ultrasonic probes 1, 2, 3 and 4 in FIG. 7 are as illustrated in FIG. 8. According to FIG. 8, the signal intensity of ultrasonic probe 2 is reduced apparently during a certain period of time due to the pass of the piece of adhesive tape. Thus, the analyzing module can determine that a thickness of the banknote is abnormal, and the thickness detection device may alarm and reject the banknote.

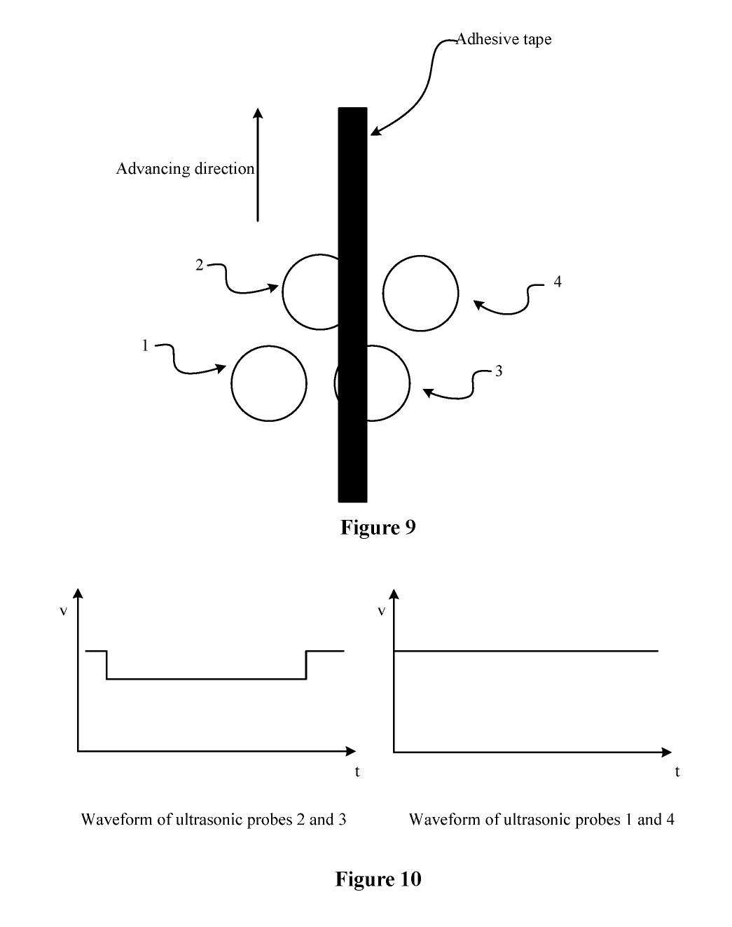

In a second case, the piece of adhesive tape passes through a sensing coverage of two ultrasonic probes, as illustrated in FIG. 9. In this case, sensing waveforms of ultrasonic probes 1, 2, 3 and 4 in FIG. 9 are as illustrated in FIG. 10. According to FIG. 10, the signal intensities of ultrasonic probes 2 and 3 are reduced apparently during a certainly period of time due to the pass of the piece of adhesive tape. Thus, the analyzing module can determine that a thickness of the banknote is abnormal, and the thickness detection device may alarm and reject the banknote.

Those skilled in the art can clearly appreciate that, for ease and conciseness of description, reference can be made to corresponding processes in the foregoing method embodiments to understand operating processes of the systems, devices and units described above, which are not described herein.

It should be understood that the systems, devices and methods disclosed with embodiments in the present disclosure may be implemented in other ways. For example, the device embodiments described above are illustrative only. For example, the division of the units is merely a logical function division and there may be other divisions in practical implementations. For example, multiple units or components may be combined or integrated into another system, or some features may be ignored or not performed. In addition, the displayed or discussed mutual couplings or direct couplings or communication connections may be indirect couplings or communication connections implemented through some interfaces, devices or units, and may be implemented in electronic, mechanical or other forms.

The units described as separate parts may or may not be physically separate, and components displayed as units may or may not be physical units, which may be located in one position or distributed on multiple network units. A part or all of the units may be selected as needed to achieve the object of the solutions in the embodiments.

In addition, functional units in the embodiments in the present disclosure may be integrated into one processing unit, or each of the units may exist alone physically, or two or more units are integrated into one unit. The integrated units above may be implemented in the form of hardware, or in the form of software functional units.

In a case that the integrated units are implemented in the form of software functional units and sold or used as a separate product, the integrated units may be stored in a computer readable storage medium. Based on such understanding, essence of the technical solutions in the present disclosure, or the part contributing to the prior art, or all or a part of the technical solutions may be implemented in the form of a software product. The computer software product is stored in a storage medium and includes several instructions for instructing a computer device (which may be a personal computer, a server, or a network device) to perform all or a part of steps of the methods described in the embodiments in the present disclosure. The storage medium includes any medium that can store program codes, such as a U-disk, a removable hard disk, a read-only memory (ROM, Read-Only Memory), a random access memory (RAM, Random Access Memory), a magnetic disk, and an optical disk.

In summary, the embodiments above are merely described to illustrate rather than limiting the technical solutions in the present disclosure. Although the technical solution is described in detail with reference to the embodiments above, those skilled in the art shall understand that alternations can be made to the technical solutions or equivalent substitutions can be made to a part of the technical features according to the described embodiments. The alternations or substitutions do not make the essence of corresponding technical solutions deviate from the spirit and the scope of the technical solutions of the embodiments in the present disclosure.

1. A thickness detection device, comprising a plurality of thickness sensors, wherein the plurality of thickness sensors are arranged in two rows in an advancing direction of a sheet medium, and the two rows are arranged in a staggered manner, such that any point on the sheet medium passes through a sensing coverage of the plurality of thickness sensors in the advancing direction.

2. The thickness detection device according to claim 1, further comprising:
a transmitting circuit board and a receiving circuit board, wherein,
the transmitting circuit board and the receiving circuit board are installed in pair, an advancing channel for the sheet medium is formed between the transmitting circuit board and the receiving circuit board; and
the plurality of thickness sensors are installed on the transmitting circuit board and the receiving circuit board.

3. The thickness detection device according to claim 2, wherein
the plurality of thickness sensors comprises transmitting probes and receiving probes;
the transmitting probes are installed on the transmitting circuit board, the receiving probes are installed on the receiving circuit board; and
the transmitting probes and the receiving probes are installed in a one-to-one correspondence relationship.

4. The thickness detection device according to claim 3, wherein
the transmitting circuit board is configured to control the transmitting probes to transmit a detection signal, which passes through the sheet medium and is received by the receiving probes as a new detection signal.

5. The thickness detection device according to claim 4, further comprising:
an analyzing module, configured to acquire the new detection signal from the receiving circuit board and perform a signal intensity analysis on the new detection signal, to obtain a thickness of the sheet medium based on a relation between signal intensity and thickness.

6. The thickness detection device according to claim 3, wherein
the transmitting probes comprise ultrasonic transmitting probes; and
the receiving probes comprise ultrasonic receiving probes.

7. The thickness detection device according to claim 5, wherein
the N pairs of transmitting probe and receiving probe are divided into X groups each comprising Y transmitting probes and Y receiving probes, wherein X multiplied by Y is N,
the transmitting probes and the receiving probes in a same group perform transmitting operations and receiving operations synchronously, and
the X groups of transmitting probes and receiving probes operate in a predetermined group sequence.

8. The thickness detection device according to claim 7, wherein the transmitting circuit board further comprises:
Y drive circuits, connected to the Y transmitting probes in each of the X groups respectively and configured to drive the transmitting probes to transmit the detection signal; and
a first one-of-X switch, connected to the X groups of transmitting probes and configured to turn on the transmitting probes in one of the X groups simultaneously in the predetermined group sequence.

9. The thickness detection device according to claim 8, wherein the receiving circuit board further comprises:
N pre-amplification circuits, connected to the N receiving probes respectively and configured to perform preliminary amplification on the new detection signal received by the receiving probes;
Y second one-of-X switches and Y amplifying and shaping circuits, wherein
each of the second one-of-X switches is connected to X of the N pre-amplification circuits and one of the Y amplifying and shaping circuits, and is configured to select the receiving probe belonging to a current group from the X receiving probes connected to the X pre-amplification circuits in the predetermined group sequence; and
each of the Y amplifying and shaping circuits is configured to perform an amplifying and shaping process on the new detection signal sent by the second one-of-X switches connected to the amplifying and shaping circuit; and
an AD converter, connected to the Y amplifying and shaping circuits and configured to perform an AD conversion on the new detection signal sent by the Y amplifying and shaping circuits and then send the new detection signal on which the AD conversion is performed to the analyzing module.

10. The thickness detection device according to claim 5, wherein
the analyzing module is further configured to determine that there is an abnormal characteristic on the sheet medium if signal intensity of the new detection signal is not within a predetermined intensity interval, wherein the abnormal characteristic comprises a tear, a breakage and a pasted foreign matter on the sheet medium; or
the analyzing module is further configured to determine that the sheet medium is defective if an average thickness of the sheet medium is not within a predetermined thickness interval.

11. The thickness detection device according to claim 7, wherein
the analyzing module is further configured to determine that there is an abnormal characteristic on the sheet medium if signal intensity of the new detection signal is not within a predetermined intensity interval, wherein the abnormal characteristic comprises a tear, a breakage and a pasted foreign matter on the sheet medium; or
the analyzing module is further configured to determine that the sheet medium is defective if an average thickness of the sheet medium is not within a predetermined thickness interval.

12. The thickness detection device according to claim 8, wherein
the analyzing module is further configured to determine that there is an abnormal characteristic on the sheet medium if signal intensity of the new detection signal is not within a predetermined intensity interval, wherein the abnormal characteristic comprises a tear, a breakage and a pasted foreign matter on the sheet medium; or
the analyzing module is further configured to determine that the sheet medium is defective if an average thickness of the sheet medium is not within a predetermined thickness interval.

13. The thickness detection device according to claim 9, wherein
the analyzing module is further configured to determine that there is an abnormal characteristic on the sheet medium if signal intensity of the new detection signal is not within a predetermined intensity interval, wherein the abnormal characteristic comprises a tear, a breakage and a pasted foreign matter on the sheet medium; or
the analyzing module is further configured to determine that the sheet medium is defective if an average thickness of the sheet medium is not within a predetermined thickness interval.
